(19) United States
(12) Patent Application Publication
(10) Pub. No.: US 2006/0110167 A1
(43) Pub. Date: May 25, 2006

(54) Clock signal generation apparatus using asymmetrical distortion of NRZ signal and optical transmission and reception system employing the same

(76) Inventors: Wangjoo Lee, Daejeon (KR); Hyunwoo Cho, Daejeon (KR); SangKyu Lim, Daejeon (KR); Ki-Ho Han, Busan (KR); Je-Soo Ko, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/284,497

(22) Filed: Nov. 21, 2005

(30) Foreign Application Priority Data
Nov. 22, 2004 (KR) 10-2004-0095914

(51) Int. Cl. H04B 10/04

(52) U.S. Cl. 398/183

(57) ABSTRACT

Provided are a clock component generating apparatus using an asymmetrical distortion of NRZ (non-return to zero) signal and an optical transmission and reception system employing it. The clock component generation apparatus can make an NRZ optical signal have large clock component by asymmetrically distorting the rising and the falling waveform of the NRZ signal utilized in an optical communication system. This apparatus includes asymmetrical pull-up circuit for producing a pull-up function and pull-down circuit for pull-down function to thereby generate a clock component in the distorted NRZ data signal. The invention may advantageously be applied to an optical transmission and reception system.

### FIELD OF THE INVENTION

The present invention relates to a clock component generation apparatus using an asymmetrical distortion of an NRZ (non-return to zero) signal and an optical transmission and reception system employing the same.

As described later, in particular, it should be noted that this invention may be applied to an optical transmitter to let an NRZ modulated optical signal contain a large clock component as an RZ modulated optical signal or to an optical receiver to let the opto-electric (O/E) converted NRZ signal include a large clock component as RZ signal for easy clock signal extraction in a receiving end.

### DESCRIPTION OF RELATED ART

Currently, it is known that an NRZ modulation scheme is the most widely used optical modulation scheme in digital optical communication. This scheme allows the equipment cost to be inexpensive due to a small bandwidth of modulation signal when sending the same amount of information, compared to RZ modulation scheme. Also, such scheme allows the bandwidth of optical wavelength conveying information to be relatively narrow; and thus, it is advantageously utilized in, particularly WDM (wavelength division multiplexing), which employs plural optical wavelengths simultaneously. In the case of RZ modulated optical signal, since it contains a large clock component, a simple device such as a band pass filter is available for the clock signal extraction needed to recover the transmitted data in a receiving end. On the other hand, in the case of NRZ modulated optical signal, since it has no clock frequency component or has very weak clock component, PLL (phase lock loop) or complex non-linear circuit is necessary to extract clock signal in the receiving end. A more concrete explanation on this will be given below.

In digital communications, a data recovery in the receiving end is conducted by reading the amplitude of input signal at every instant designated by a clock signal and then deciding whether the signal is data of “0” or “1.” Specifically, in the transmitting end, optical data signal can be sent in synchronization with its own clock. In the receiving end, however, since correct data cannot be recovered if the clock frequency in the receiving end is different from that of the transmitting end, most of receivers do not have its own clock, but extracts clock signal from the input data synchronized with the transmitting clock and employ it for recovering the transmitted data.

Conventionally, since the NRZ modulation scheme needs a narrow signal bandwidth as well as a simple modulation device when transmitting the same amount of information, it is the most widely used optical signal modulation scheme in the optical communication. However, as NRZ modulated optical signal does not include clock component theoretically, or it actually has only a small clock component occurred due to non-ideal characteristic of devices used in the transceiver, the clock extraction device used for the NRZ modulated optical signal in the receiving end is much complicated, compared to those for the RZ modulated optical signal.

A traditional clock extraction method for NRZ signal employs PLL device, in which it performs an opto-electric conversion of the transmitted optical signal, branches off the signal in the electrical domain and applies a part thereof to the PLL circuit, and uses the output of the PLL circuit as clock signal. However, since the advent of the optical communication, transmission data rate of more than 40 Gbps is actively used now. For this high frequency region, it is very difficult to manufacture electrical devices such as PLL, etc., and usually they are very expensive.

Meanwhile, there exists another clock signal extraction method of employing exclusive OR and band pass filtering. This method branches a part of opto-electric converted signal and divides one of the branched parts into two. It then takes an exclusive OR operation on the divided signals where one of the divided signals is time delayed by a half period of nominal clock signal relative to the other divided signal. By narrowing band pass filtering, the exclusive OR output clock signal can be obtained. However, since such method must conduct the signal division as well as delay and exclusive OR operations with band pass filtering, its structure is also complicated.

### SUMMARY OF THE INVENTION

It is, therefore, a primary object of the present invention to provide a simple clock signal generation method employing an asymmetrical distortion of NRZ signal in an optical communication system.

The other objectives and advantages of the invention will be understood by the following description and also will be seen by the embodiments of the invention more clearly. Further, the objectives and advantages of the invention will readily be seen that they can be realized by the means and its combination specified in the claims.

In accordance with an aspect of the present invention, there is provided an apparatus for generating a clock signal by using an asymmetrical distortion of an NRZ (non-return to zero) signal, the apparatus including: a pull-up means for producing a pull-up signal; and a pull-down means for creating a pull-down signal, wherein a current driving capacity of the pull-up means and the pull-down means is different, and an NRZ signal from the apparatus has an asymmetrical output characteristic that a rising and falling time is different, to thereby generate a clock component in the NRZ data signal passing through the apparatus having the asymmetrical output.

In accordance with another aspect of the present invention, there is provided an optical transmission system using NRZ modulation, including: a laser source for outputting a light signal; an NRZ signal generator for generating NRZ signals based on the light signal; a modulator driver for amplifying the NRZ signals; and an optical modulator for modulating the light signal outputted from the light source into NRZ optical signals based on the amplified NRZ signals, wherein the NRZ signal generator includes a clock component generator which includes: a pull-up means for producing a pull-up signal; and a pull-down means for creating a pull-down signal, wherein a current driving capacity of the pull-up means and the pull-down means is different, and an NRZ signal from the clock component generator has an asymmetrical output characteristic that a rising and falling time is different, to thereby generate a clock component in the NRZ data signal passing through the clock component generator having the asymmetrical output characteristic.

In accordance with another aspect of the present invention, there is provided an optical reception system receiving an NRZ signal having clock component, wherein the clock component is generated by passing through a clock component generation apparatus having the asymmetrical output characteristic in the optical transmitting system, the system including: a band pass filter for extracting a clock signal by band pass filtering the received NRZ data signal with clock component.

In accordance with another aspect of the present invention, there is provided an optical reception system receiving an NRZ optical signal, the system including: an opto-electric converter for converting an NRZ optical signal into an electric signal; a limiting amplifier for amplifying the electric signal to have a predetermined amplitude of voltage, wherein the limiting amplifier has a clock component generator which includes: a pull-up means for producing a pull-up signal; and a pull-down means for creating a pull-down signal, wherein a current driving capacity of the pull-up means and the pull-down means is different, and an NRZ signal from the clock component generator has an asymmetrical output characteristic that a rising and falling time is different, to thereby generate a clock component in the NRZ data signal passing through the clock component generator having the asymmetrical output characteristic.

Generally, when an optical signal is modulated and a modulation signal has a clock component, a modulated optical signal comes to have a clock component. When the modulation signal does not have a clock component, the modulated optical signal does not have a clock component or has a very weak clock component, which is generated by non-ideal characteristics of an actual device. An RZ modulation signal has a large clock signal but the NRZ modulation signal does not have any clock component theoretically.

Therefore, in the present invention, the NRZ signal is made to have a large clock component by distorting the NRZ signal a little bit to make it easy to extract clocks although the size of the color component is smaller than the RZ signal.

For this, the present invention allows the NRZ signal being handled to include large clock component by a certain device in the transmission end having asymmetrical output characteristic, and extracts clock signal by band pass filtering this in the reception end.

Herein, optical modulation is carried out in a reception end for the NRZ-modulated optical signal to make it easy to extract colors in the reception end and include a large clock component in the present invention. That is, the optical signal transmitted from a transmitting end is modulated to have a larger clock component than a general NRZ-modulated optical signal in the present invention so that the reception end can extract clocks stably with inexpensive devices, such as a band-pass filter and a general amplifier.

Also, the present invention may allow the typical NRZ signal being handled to include a large clock component by a certain device in the reception end having asymmetrical output characteristic, and extracts clock signal by band pass filtering.

### BRIEF DESCRIPTION OF THE DRAWINGS

The above and other objects and features of the instant invention will become apparent from the following description of preferred embodiments taken in conjunction with the accompanying drawings, in which:

FIG. 1 is a diagram illustrating ideal NRZ and RZ modulated waveforms;

FIG. 2 is a diagram showing NRZ modulated waveform with finite rising and falling time;

FIG. 3 is an explanation diagram representing an integration interval for deriving the amplitude of clock component of NRZ modulated waveform with finite rising time and falling time;

FIG. 4 is a diagram illustrating NRZ modulated PRBS (pseudo random binary sequence) signal waveform where the clock frequency corresponding to the data is 0.1 of arbitrary unit;

FIG. 5 is a simulated frequency spectrum of FIG. 4 data when the rising and falling waveforms are symmetrical both with 20% period of one bit period;

FIG. 6 is a simulated frequency spectrum of FIG. 4 data when the rising and falling waveforms are asymmetrical such as 20% and 40% of one bit period, respectively;

FIG. 7A is a block diagram showing a typical configuration of an NRZ optical transmitter to which the present invention can be applied;

FIG. 7B is a block diagram depicting a typical configuration of an NRZ optical receiver to which the present invention can be applied;

FIG. 7C is a configuration diagram representing one embodiment of an optical receiver that extracts a clock signal by band pass filtering, where a clock component generation apparatus of the invention using an asymmetrical distortion of NRZ signal is applied;

FIG. 8 is an output port structure based on the CMOS (complementary mental oxide semiconductor) technology which can be used for the asymmetrical distortion of NRZ signal in accordance with an embodiment of the invention by asymmetrically adjusting the pull-up and pull-down capability;

FIG. 9 is a measured frequency spectrum by conducting an opto-electric (O/E) conversion of a symmetrical NRZ optical signal using a O/E conversion device of asymmetrical output characteristics in accordance with the invention; and

FIG. 10 shows an extracted clock signal of 42.83 GHz, which is obtained by asymmetrical opto-electric conversion of optical NRZ signal and then band pass filtering the O/E converted signal in accordance with the invention.

### DETAILED DESCRIPTION OF THE INVENTION

The objects, features, and advantages will be apparent by the following detailed description in associated with the accompanying drawings. With the detailed description and the drawings, the technical spirit of the invention will readily be conceived by those skilled in the art to which the invention belongs. Further, if it is assumed that a concrete explanation of the known art used in the invention may blur the points of the present invention in the following description, such explanation will be omitted for the sake of clearness. Hereinafter, a preferred embodiment of the present invention will be described in detail with reference to the accompanying drawings.

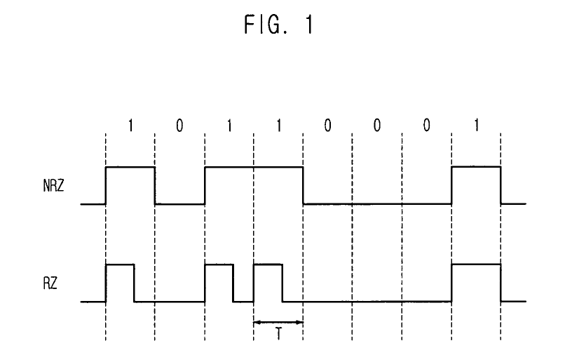

FIG. 1 shows a diagram illustrating ideal NRZ and RZ modulated waveforms.

In the digital communication, sequential random data of “0” and “1” are sent and received. In the NRZ modulation scheme, in case of the data “0”, as shown in FIG. 1, its signal level is continuously logic low for one bit interval; and in case of the data “1”, it is continuously maintained at logic high level for one bit interval.

Contrary to this, in the RZ modulation scheme, in case of the data “0”, its signal level is continuously logic low for one bit interval; and in case of the data ‘1”, it is logic high only for a part, e.g., 50% or 60% of one bit interval, and logic low for the remaining period.

In other words, the duty of NRZ signal is 100%, while the duty of RZ signal is 50% or 60%. It is well known that the RZ signal of less than 100% duty has a strong clock component, and the NRZ signal of 100% duty does not have clock component. Hereinafter, it will be shown that the NRZ signal may also contain clock component if it has a finite asymmetrical rising and falling waveform. And, a scheme of creating clock component in NRZ modulated optical signal using the above will also be discussed in detail.

The size of the clock component in the NRZ signal is derived by doing Fourier transformation of NRZ signal at the clock frequency. For example, if the NRZ modulated signal is M(t), and the result of Fourier transformation on this is F(ω), then the size of clock component may be calculated as:

$$\begin{matrix}F ( {ω}_{clk} ) = {\int }_{- ∞}^{∞} M ( t ) \cdot {ⅇ}^{- j {ω}_{clk} t} ⅆ t \\ = {\int }_{- ∞}^{∞} M ( t ) \cdot cos ( {ω}_{clk} t ) ⅆ t - j {\int }_{- ∞}^{∞} M ( t ) \cdot sin ( {ω}_{clk} t ) ⅆ t\end{matrix} \qquad Eq . ( 1 )$$

Where, in Eq. (1), ω_{clk}=2πf_{clk} and f_{clk} and t represent clock frequency and time, respectively. And, if one bit interval is T(=1/f_{clk}), then Eq. (2) may be derived from Eq. (1) as:

$$F ( {ω}_{clk} ) = {\sum }_{k = - ∞}^{∞} {\int }_{( k - 1 ) T}^{kT} M ( t ) \cdot cos ( {ω}_{clk} t ) ⅆ t - j {\sum }_{k = - ∞}^{∞} {\int }_{( k - 1 ) T}^{kT} M ( t ) \cdot sin ( {ω}_{clk} t ) ⅆ t \qquad Eq . ( 2 )$$

In Eq. (2), there are cosine term and sine terms that denote the real number part and the imaginary number part, respectively. Since they are not amplified or cancelled by mutual interference, only the cosine term will be discussed below to show the presence or absence of clock component in the modulation signal. If the modulated waveform is ideal one, then M(t) continues to maintain a value of “0” or “1” in Eq. (2) without any change thereof during one bit interval. In this case, in Eq. (2) each integration term where M(t) is “0” becomes zero; and each term where M(t) is “1” also becomes zero, due to an integrity of trigonometric function, cos(ω_{clk}f), done for one period. Thus, there exists no clock component. In actual, however, results other than the above may be issued because NRZ modulation waveform has finite rising and falling time.

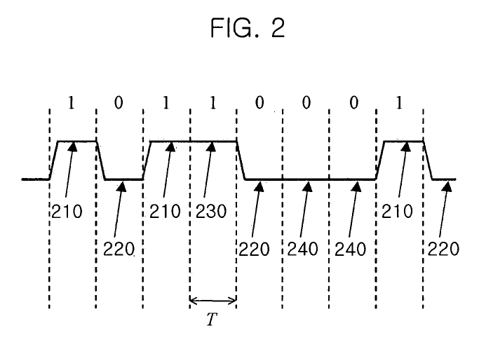

FIG. 2 is a diagram illustrating NRZ modulated waveform with finite rising and falling time.

Referring to FIG. 2, there exist four different waveforms for each bit interval merely: a reference number “210” for a section where just previous data is “0” and changed to “1”, a reference number “220” for a section where just previous data is “1” and changed to “0”, a reference number “230” for a section where just previous data “1” continues to maintain “1”, and a reference number “240” for a section where just previous data “0” continues to maintain “0”.

Since the sections continuing the same data as in the sections “230” and “240” are identical to ideal waveform even though the global NRZ modulated signal has a finite rising and falling time, the integral term of Eq. (2) for this interval becomes zero. Except for these sections, there remain modulated signal sections such as “210” and “220”, in which the bit state changes from the just previous bit state. A size of clock component having this waveform will be derived below.

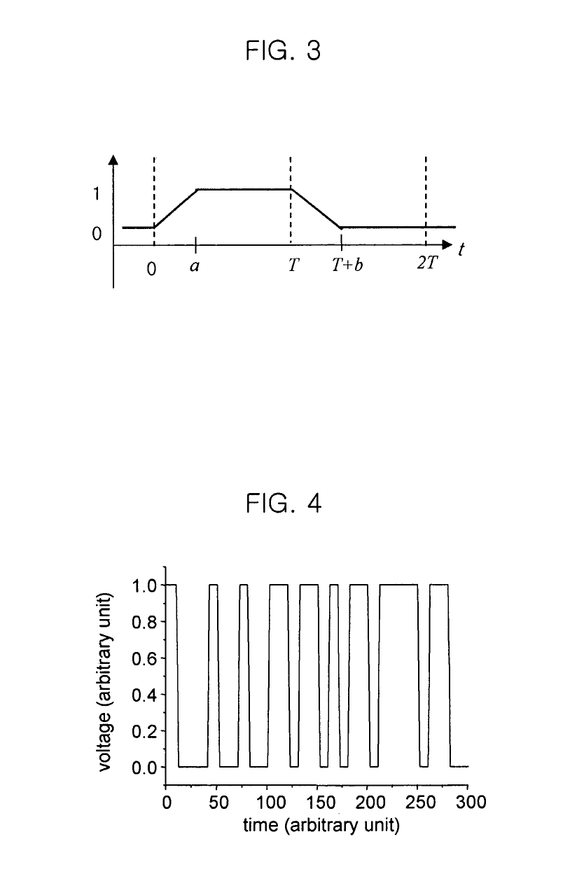

FIG. 3 is a diagram showing the integration interval for deriving the size of clock component of NRZ modulation waveform with the finite rising and falling time and bit state change.

The size of clock component is calculated as the flowing equation Eq. (3), allowing the clock component to be non-zero when the rising and falling times are different(a≠b).

$$\begin{matrix}{F}_{1 bit} ( {ω}_{clk} ) = {\int }_{0}^{a} \frac{t}{a} \cdot cos ( {ω}_{clk} t ) ⅆ t + {\int }_{a}^{T} cos ( {ω}_{clk} t ) ⅆ t + \\ {\int }_{0}^{b} ( 1 - \frac{t}{b} ) \cdot cos ( {ω}_{clk} t ) ⅆ t \\ = \frac{1}{{ω}_{clk}} sin ( {ω}_{clk} a ) + \frac{1}{{ω}_{clk}^{2} a} cos ( {ω}_{clk} a ) - \frac{1}{{ω}_{clk}^{2} a} - \\ \frac{1}{{ω}_{clk}} sin ( {ω}_{clk} a ) + \frac{1}{{ω}_{clk}} sin ( {ω}_{clk} b ) - \\ \frac{1}{{ω}_{clk}} sin ( {ω}_{clk} b ) - \frac{1}{{ω}_{clk}^{2} b} cos ( {ω}_{clk} b ) + \frac{1}{{ω}_{clk}^{2} b} \\ = \frac{1}{{ω}_{clk}^{2} a} cos ( {ω}_{clk} a ) - \frac{1}{{ω}_{clk}^{2} a} - \frac{1}{{ω}_{clk}^{2} b} cos ( {ω}_{clk} b ) + \\ \frac{1}{{ω}_{clk}^{2} b} \\ \neq 0\end{matrix} \qquad Eq . ( 3 )$$

However, if the rising time is the same as the falling time, i.e., if a=b in Eq. (3), then Eq. (3) becomes zero, resulting in a non-issuance of clock component as in the ideal NRZ signal.

From the above discussion, in order to let the NRZ modulation signal have a substantial clock component, it needs to make the rising and falling time of the waveform asymmetrical. By doing so, such asymmetrically distorted NRZ signal whether it is optical or electrical can include clock component. Furthermore, according to Eq. (3), by optimizing the rising and falling time, it can be regulated to have the largest clock component within the range of not degrading the quality of signal.

FIG. 4 is a diagram illustrating a part of the NRZ modulated PRBS (pseudo-random binary sequence) signal waveform, which is a standard data pattern widely used for the test purpose in optical communications.

The PRBS pattern is a pre-determined random combination of “0” and “1”.

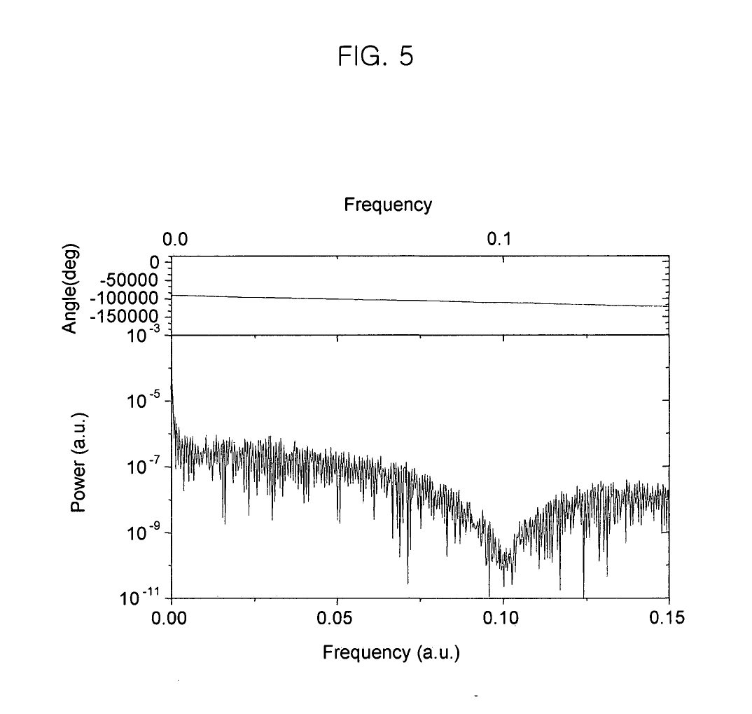

FIG. 5 is a simulated frequency spectrum obtained when the rising and falling time in FIG. 4 is symmetrical as 20% of one bit period. We set the length of one bit time(T) in FIG. 4 as 10 (arbitrary unit) so the clock frequency (f_{clk}=1/T) corresponds to 0.1 (arbitrary unit).

As shown in FIG. 5, in case of the NRZ signal waveform with the same rising and falling time, there is not shown any frequency component at 0.1, which means that the data waveform does not contain any clock frequency component.

In the simulation, it is assumed that the rising and falling time is all 20% of one bit period; but, actually it does not need to be 20%, and always reaches the same conclusion if the rising and falling time are the same (symmetrical).

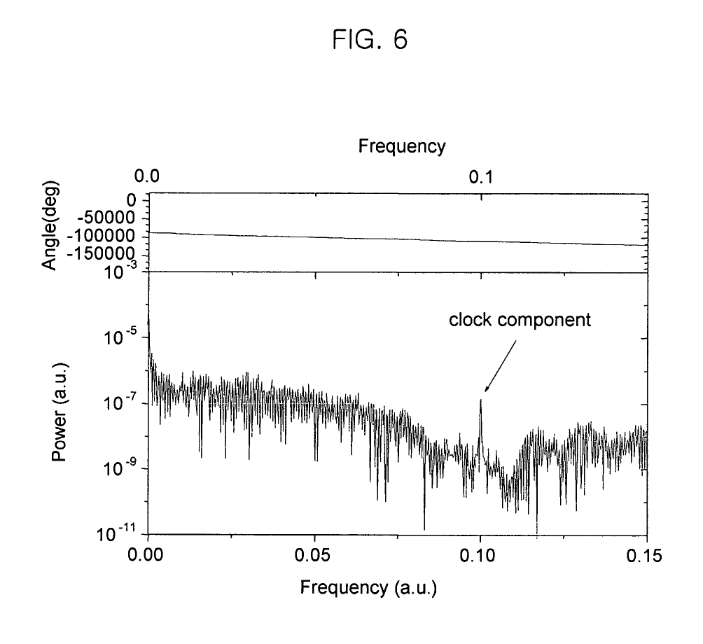

FIG. 6 is a simulated frequency spectrum when the rising and falling time in FIG. 4 is asymmetrical as 20% and 40% of one bit period, respectively. In comparison with FIG. 5, it can evidently be seen from FIG. 6 that a clock component at 0.1 (arbitrary unit) is created.

The present invention may apply a device with asymmetrical output characteristic to an NRZ optical transmitter, or to an NRZ optical receiver in order to make NRZ signal have a large clock component before clock extraction circuit input.

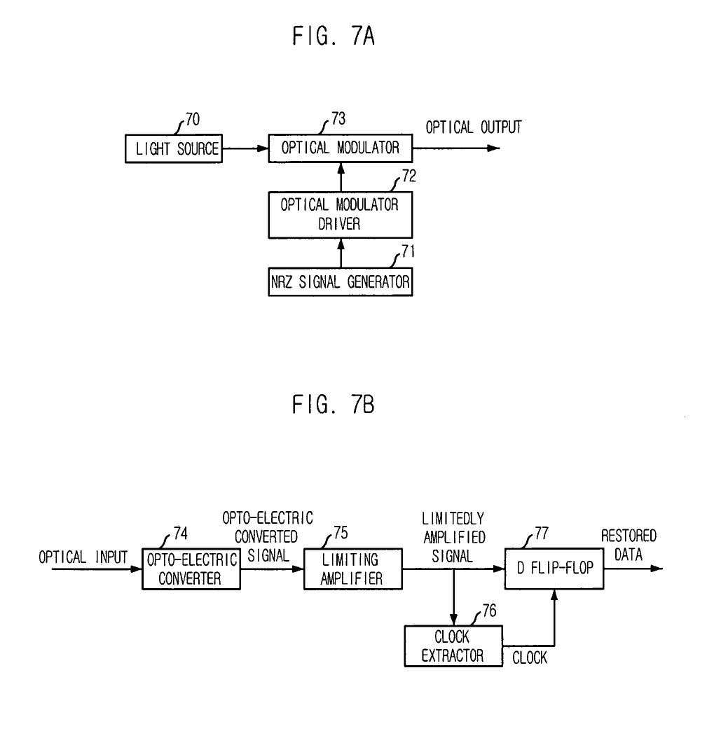

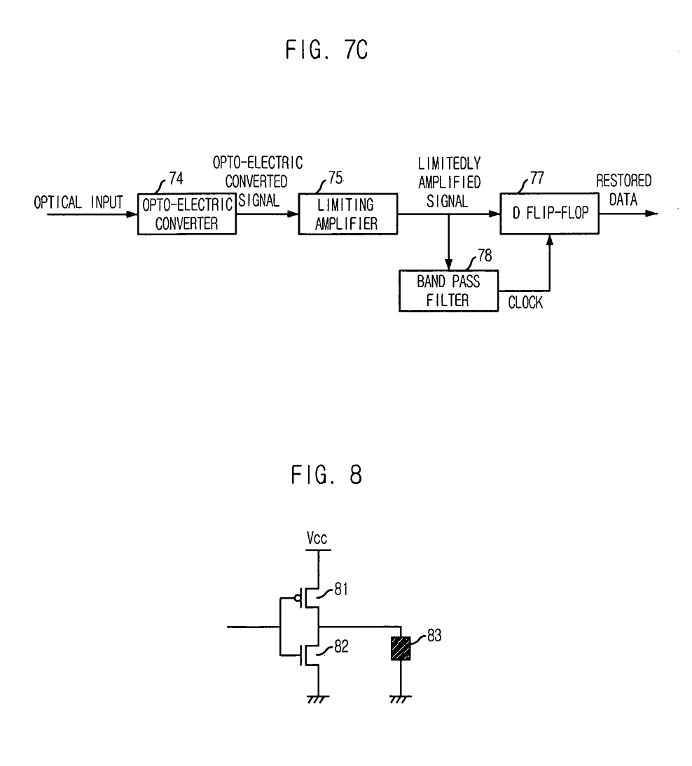

FIG. 7A and FIG. 7B shows the typical NRZ optical transmitter and receiver configuration.

As shown in FIG. 7A, an NRZ electrical signal from an NRZ signal generator 71 in an optical transmitter is amplified in an optical modulator driver 72. Then, it is applied to an optical modulator 73 for modulating the emitted light from a light source 70, e.g., LD (laser diode), as NRZ optical signal.

In an optical receiver, as shown in FIG. 7B, the NRZ optical signal is provided to an opto-electric converter 74 that conducts opto-electric conversion of the signal. It is then transferred to a limiting amplifier 75 for amplifying the opto-electric converted signal to a constant amplitude voltage level, regardless of the input amplitude. Then, a part of the limitedly amplified signal is delivered to a D flip-flop 77 as data recover, while another part thereof is transferred to a clock extractor 76.

The conventional clock extractor 76 is composed of a circuit using PLL device or exclusive OR gate, and the clock signal extracted from the clock extractor 76 is delivered to the D flip-flop 77, to thereby recover the transmitted data.

Herein, the asymmetrical NRZ signal required in the present invention can be created by designing and manufacturing a device in such a way that a pull-up and pull-down characteristic of the output port of the device is asymmetric. For instance, if it is manufactured that the pull-up driving capacity of the device is larger than the pull-down driving capacity, then the rising time of the output signal becomes shorter compared to its falling time; and vice versa.

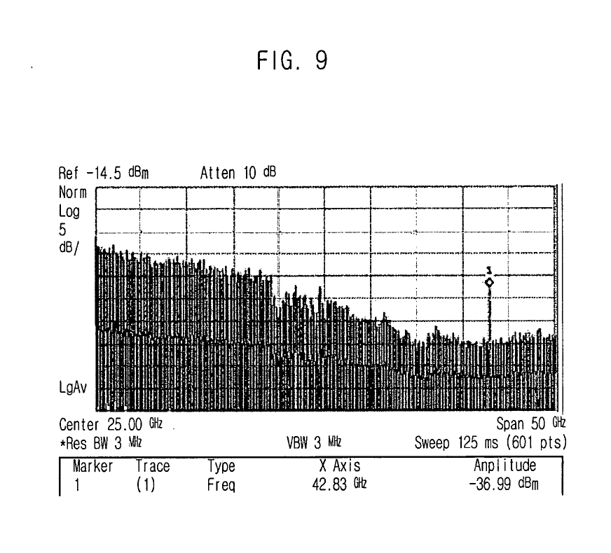

Now, the asymmetrical output characteristic of a device will be discussed using a typical CMOS device with reference to FIG. 8.

FIG. 8 is a configuration illustrating a typical output structure of a CMOS device.

The output structure of the CMOS device is configured in such a manner that a PMOS transistor 81 for the pull-up function and an NMOS transistor 82 for the pull-down function are connected between VCC and GND in series, thus issuing an output at a connection point between the PMOS transistor 81 and the NMOS transistor 82 and driving a load 83 using the output.

Herein, designing and manufacturing the current driving capacity of the PMOS transistor 81 and the NMOS transistor 82 differently can obtain a desired form of asymmetrical output.

Thus, a clock component can be created in the output NRZ signal passing through the device with the asymmetrical output characteristic.

If the clock component generation apparatus of the present invention is employed in the optical transmitter, the configuration of the transmitter is the same as FIG. 7A, and but, it needs to make sure that the NRZ signal generator 71 or the optical modulator driver 72 has the asymmetrical output characteristic. At this time, a receiver is configured that the clock extractor 76 is substituted with a simple band pass filter 78, as in FIG. 7C. In this case, the amplitude of the extracted clock signal may be further amplified by a general amplifier before the D flip-flop 77 input, if necessary.

Also, if the clock component generation apparatus of the invention is employed in the optical receiver, the configuration of the receiver is the same as FIG. 7B, and but, it needs to make that the output port characteristic of the opto-electric converter 74 or the limiting amplifier 75 is asymmetric.

FIG. 9 is a measured frequency spectrum of the opto-electric converted NRZ signal of 42.83 Gb/s data rate using a opto-electric converter with asymmetrical output port characteristic in accordance with the invention.

As shown in FIG. 9, it can be seen that there is included a very large clock component at 42.83 GHz (Marker1).

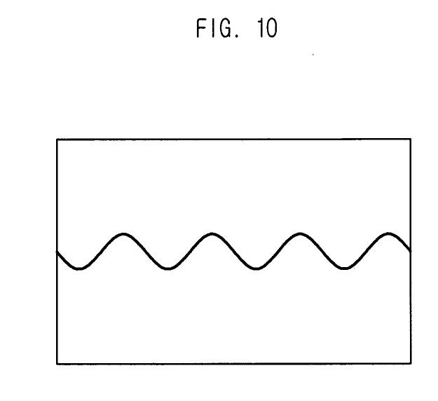

FIG. 10 is a measured waveform of the clock signal of 42.83 GHz, which is obtained by band pass filtering the asymmetrically opto-electric converted NRZ signal of FIG. 9 in accordance with the invention.

As depicted in FIG. 10, it can be seen that the shape of the clock signal issued from the band pass filter 78 is very clean.

As mentioned above, the present invention can provide large clock component with respect to the NRZ signal of no clock component or weak clock component conventionally, by asymmetrically distorting the rising and falling waveform using a specially prepared device in the optical transmission or reception system. In both cases, the clock extraction in the receiver can be simply done only by band pass filtering the NRZ signal containing a large clock component created by the above-described method, thus implementing the system simple and inexpensive due to simple configuration of the clock extraction circuit.

The present application contains subject matter related to Korean patent application No. 2004-0095914, filed with the Korean Intellectual Property Office on Nov. 22, 2004, the entire contents of which is incorporated herein by reference.

While the present invention has been described with respect to the particular embodiments, it will be apparent to those skilled in the art that various changes and modifications may be made without departing from the spirit and scope of the invention as defined in the following claims.

What is claimed is:

1. An apparatus for generating a clock signal by using an asymmetrical distortion of an NRZ (non-return to zero) signal, the apparatus comprising:
a pull-up means for producing a pull-up signal; and
a pull-down means for creating a pull-down signal,
wherein a current driving capacity of the pull-up means and the pull-down means is different, and an NRZ signal from the apparatus has an asymmetrical output characteristic that a rising and falling time is different, to thereby generate a clock component in the NRZ data signal passing through the apparatus having the asymmetrical output characteristic.

2. The apparatus as recited in claim 1, wherein the apparatus having the asymmetrical output characteristic is a CMOS transistor.

3. The apparatus as recited in claim 2, wherein the CMOS transistor, where a PMOS transistor for pull-up operation and an NMOS transistor for pull-down operation are connected between a supply voltage VCC and the ground GND in series, drives a load using an output from a connection point between the PMOS transistor and the NMOS transistor, and it is designed and manufactured that the current driving capacity of the PMOS transistor and the NMOS transistor is different, to make a desired form of asymmetrical output.

4. The apparatus as recited in claim 1, wherein the apparatus is operated that if the pull-up driving capacity of an output end is larger than the pull-down capacity, a rising time of the output signal is faster than a falling time, and if the pull-up driving capacity is less than the pull-down capacity, the rising time of the output signal is slower than the falling time.

5. An optical transmission system using NRZ modulation, comprising:
a laser source for outputting a light signal;
an NRZ signal generator for generating NRZ signals based on the light signal;
a modulator driver for amplifying the NRZ signals; and
an optical modulator for modulating the light signal outputted from the light source into NRZ optical signals based on the amplified NRZ signals,
wherein the NRZ signal generator includes a clock component generator which includes:
a pull-up means for producing a pull-up signal; and
a pull-down means for creating a pull-down signal,
wherein a current driving capacity of the pull-up means and the pull-down means is different, and an NRZ signal from the clock component generator has an asymmetrical output characteristic that a rising and falling time is different, to thereby generate a clock component in the NRZ data signal passing through the clock component generator having the asymmetrical output characteristic.

6. The system as recited in claim 5, wherein the clock component generator is a CMOS transistor; and the CMOS transistor, where a PMOS transistor for pull-up operation and an NMOS transistor for pull-down operation are connected between a supply voltage VCC and the ground GND in series, drives a load using an output from a connection point between the PMOS transistor and the NMOS transistor, and it is designed and manufactured that the current driving capacity of the PMOS transistor and the NMOS transistor is different, to make a desired form of asymmetrical output.

7. An optical reception system receiving an NRZ (non-return to zero) signal having clock component, wherein the clock component is generated by passing through a clock component generation apparatus having the asymmetrical output characteristic in the optical transmitting system, comprising:
a band pass filter for extracting a clock signal by band pass filtering the received NRZ data signal with clock component.

8. The system as recited in claim 7, further comprising an amplifying means for amplifying the amplitude of the extracted clock signal and transferring an amplified clock to a data recovery unit.

9. An optical reception system receiving an NRZ optical signal, comprising:
an opto-electric converter for converting an NRZ optical signal into an electric signal;
a limiting amplifier for amplifying the electric signal to have a predetermined amplitude of voltage,
wherein the limiting amplifier has a clock component generator which includes:
a pull-up means for producing a pull-up signal; and
a pull-down means for creating a pull-down signal,
wherein a current driving capacity of the pull-up means and the pull-down means is different, and an NRZ signal from the clock component generator has an asymmetrical output characteristic that a rising and falling time is different, to thereby generate a clock component in the NRZ data signal passing through the clock component generator having the asymmetrical output characteristic.

10. The system as recited in claim 9, wherein the clock component generator having the asymmetrical output characteristic is a CMOS transistor; and the CMOS transistor, where a PMOS transistor for pull-up operation and an NMOS transistor for pull-down operation are connected between a supply voltage VCC and the ground GND in series, drives a load using an output from a connection point between the PMOS transistor and the NMOS transistor, and it is designed and manufactured that the current driving capacity of the PMOS transistor and the NMOS transistor is different, to make a desired form of asymmetrical output.
